(19) United States
(12) Patent Application Publication
(10) Pub. No.: US 2014/0287218 A1
(43) Pub. Date: Sep. 25, 2014

(54) THERMALLY ADHESIVE POLYIMIDE FILM AND METHOD FOR PRODUCING SAME, AND POLYIMIDE METAL LAMINATE PRODUCED USING THERMALLY ADHESIVE POLYIMIDE FILM

(71) Applicants: Takuro Kochiyama, Ube-shi (JP); Keigo Nagao, Ube-shi (JP); Takeshi Uekido, Ube-shi (JP); Hideo Arihara, Ube-shi (JP)

(72) Inventors: Takuro Kochiyama, Ube-shi (JP); Keigo Nagao, Ube-shi (JP); Takeshi Uekido, Ube-shi (JP); Hideo Arihara, Ube-shi (JP)

(73) Assignee: UBE INDUSTRIES, LTD., Ube-shi, Yamaguchi (JP)

(21) Appl. No.: 14/240,717

(22) PCT Filed: Aug. 17, 2012
(86) PCT No.: PCT/JP2012/070884

§ 371 Date: Jun. 12, 2014

(30) Foreign Application Priority Data
Aug. 25, 2011 (JP) 2011-183892

(51) Int. Cl. B32B 15/088; B32B 37/10; C08J 5/18; B32B 7/12; C08G 69/26

(52) U.S. Cl. CPC B32B 15/088; B32B 7/12; C08G 69/26; C08J 5/18; B32B 37/10; B32B 2307/748; B32B 2457/08; C08J 2377/10
USPC 428/220; 428/458; 528/353; 264/331.19; 156/60

(57) ABSTRACT

A single-layered thermally adhesive polyimide film; a method for producing the thermally adhesive polyimide film; and a method for producing a polyimide metal laminate produced using the thermally adhesive polyimide film. The single-layer thermally adhesive polyimide film is produced by polymerizing a tetracarboxylic acid dianhydride component and a diamine component, wherein the tetracarboxylic acid dianhydride component includes 2,3,3′,4′-biphenyltetracarboxylic acid dianhydride and 3,3′,4,4′-biphenyltetracarboxylic acid dianhydride and the diamine component includes an aromatic diamine compound represented by the following formula (I) as a main component

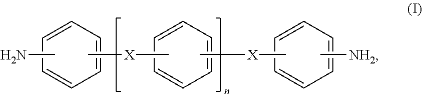

wherein X is O, CO, C(CH₃)₂, CH₂, SO₂, S, or a direct bond, and in cases of two or more modes of bonding, each is the same or different; and n is an integer of 0 to 4.

### TECHNICAL FIELD

The present invention relates to a thermally adhesive polyimide film and to a method for producing same. The present invention also relates to a polyimide/metal laminate obtained using a thermally adhesive polyimide film.

### BACKGROUND ART

Polyimide films have been widely used as substrate materials for flexible printed circuit boards (FPCs), tape-automated bonding (TAB), and the like.

Methods for bonding a polyimide film and a copper foil together include using an adhesive such as an epoxy resin or an acrylic resin.

As a method for bonding a polyimide film and a copper foil together without using the aforementioned adhesive, patent document 1 discloses a multilayered polyimide film having a thermally adhesive polyimide layer on both sides of a heat-resistant polyimide layer.

Patent document 2 also discloses a method for applying by casting a thermoplastic polyimide solution onto a release film and drying to obtain a thermoplastic polyimide film provided with a release film.

### PRIOR ART DOCUMENTS

### Patent Documents

[Patent Document 1] Japanese Laid-Open Patent Application No. 2004-230670

[Patent Document 2] Japanese Laid-Open Patent Application No. H11-10664

### DISCLOSURE OF THE INVENTION

### Problems to be Solved by the Invention

In patent document 2, there has been a desire for further improvements for the purpose of practical realization, such as to the ability of the thermoplastic polyimide film to be released from the release film, or the peel strength between the thermoplastic polyimide film and an adherend such as a copper foil.

That is to say, the release film and the thermoplastic resin are thermally adhered in the production process, and improving the releasability thereof could possibly lead to reducing the thermal adhesiveness of the thermoplastic resin. Reducing the thermal adhesiveness of the thermoplastic resin could also cause a decrease in the adhesion when the thermoplastic resin is bonded to an adherend such as a metal. In other words, the thermoplastic polyimide film calls for the contradictory properties of low adhesion to the release film and high adhesion to the adherend.

An objective of the present invention is to provide a thermally adhesive polyimide film, a method for producing a thermally adhesive polyimide film, and a polyimide/metal laminate obtained using a thermally adhesive polyimide film, with which the above-described improvements are attempted.

### Means to Solve the Problems

The present invention relates to the following features.

(1) A single-layer thermally adhesive polyimide film obtained by polymerizing a tetracarboxylic dianhydride component and a diamine component, the thermally adhesive polyimide film being characterized in that:

the tetracarboxylic dianhydride component includes a 2,3,3′,4′-biphenyl tetracarboxylic dianhydride and a 3,3′,4,4′-biphenyl tetracarboxylic dianhydride,

the diamine component includes an aromatic diamine compound represented by formula (I), as a main component;

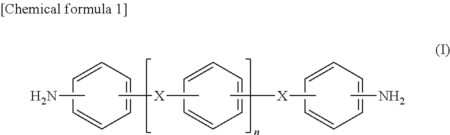

(where X is O, CO, C(CH₃)₂, CH₂, SO₂, S, or a direct bond, and in cases of two or more modes of bonding, each may be the same or different; and n is an integer of 0 to 4)

and in a polyimide/copper foil laminate obtained by placing an 18-μm copper foil onto both sides of the thermally adhesive polyimide film and pressing the resulting assembly for one minute at a temperature of 340° C. and a pressure of 3 MPa to bond the thermally adhesive polyimide film and the copper foil together, the peel strength as measured by the method in JIS C6471 is 1 N/mm or higher for both sides.

(2) The thermally adhesive polyimide film as set forth in (1), the thickness of the polyimide film being 15 to 50 μm.

(3) The thermally adhesive polyimide film as set forth in (1) or (2), the aromatic diamine compound being 1,3-bis(4-aminophenoxy)benzene.

(4) A polyimide/metal laminate obtained by laminating a metallic layer onto both sides of the thermally adhesive polyimide film as set forth in any of (1) to (3).

(5) A method for producing a single-layer thermally adhesive polyimide film, the method including a step for casting or applying a polyamic acid solution onto a carrier film and drying the resulting film, and

a step for heat-treating the resulting dried article to obtain a thermally adhesive polyimide film provided with a carrier film, the method being characterized in that:

the polyamic acid solution is obtained by polymerizing a tetracarboxylic dianhydride component and a diamine component, the tetracarboxylic dianhydride component including 2,3,3′,4′-biphenyl tetracarboxylic dianhydride and 3,3′,4,4′-biphenyl tetracarboxylic dianhydride, and the diamine component including an aromatic diamine compound represented by formula (I) as a main component,

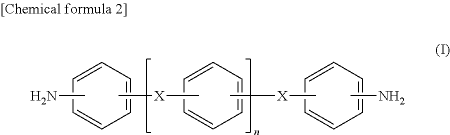

(where X is O, CO, C(CH₃)₂, CH₂, SO₂, S, or a direct bond, and in cases of two or more modes of bonding, each may be the same or different; and n is an integer of 0 to 4)

and the carrier film is a polyimide film, the thickness of the polyimide film being 50 μm or higher.

(6) The method for producing a thermally adhesive polyimide film as set forth in (5), the maximum temperature of the heat-treatment of the dried article being 430° C. or lower.

(7) The method for producing a thermally adhesive polyimide film as set forth in (5) or (6), the method including releasing the carrier film from the thermally adhesive polyimide film provided with the carrier film.

(8) The method for producing a thermally adhesive polyimide film as set forth in any of (5) to (7), the polyimide film serving as the carrier film being obtained by polymerizing a tetracarboxylic dianhydride component and a diamine component to obtain a polyamic acid solution, casting or applying the polyamic acid solution onto a support, and drying the resulting support to obtain a self-supporting film, and thereafter heating and imidizing the self-supporting film; the polyamic acid solution being cast or applied onto a side of the carrier film with which the support had not been in contact.

(9) A method for producing a double-sided polyimide/metal laminate, the method including placing a metallic layer onto both sides of the single-layer thermally adhesive polyimide film obtained in (7), from which the carrier film has been released, and thermally compression-bonding the thermally adhesive polyimide film and the metallic layers together.

(10) A method for producing a polyimide/metal laminate onto one side of which a metallic layer has been laminated, the method including placing a metallic layer onto the side to which the carrier film had not been attached, out of both sides of the single-layer thermally adhesive polyimide film obtained in (7), from which the carrier film has been released, and thermally compression-bonding the thermally adhesive polyimide film and the metallic layer together.

### Advantageous Effects of the Invention

According to the present invention, it is possible to obtain a single-layer thermally adhesive polyimide film that has favorable releasability from a carrier film. Thermally compression-bonding this thermally adhesive polyimide film and a metallic layer, such as a copper foil, also makes it possible to obtain a polyimide/metal laminate. The polyimide/metal laminate has a high peel strength between the polyimide film and the metallic layer.

### MODE FOR CARRYING OUT THE INVENTION

### Thermally Adhesive Polyimide Film

The thermally adhesive polyimide film of the present invention is obtained by polymerizing a tetracarboxylic dianhydride component and a diamine component.

Herein, “thermally adhesive” refers to the softening point of a polyimide film surface being less than 350° C. The softening point is the temperature at which an object softens rapidly during heating; the softening point is the glass transition temperature (Tg) for amorphous polyimides and is the melting point for crystalline polyimides. Hereinbelow, “thermally adhesive” is in some instances referred to as “thermoplastic.”

Further, “single layer” in the single-layer thermally adhesive polyimide film refers to there being no other layer in contact with both sides of the thermally adhesive polyimide film.

The tetracarboxylic dianhydride component used in the present invention includes a 2,3,3′,4′-biphenyl tetracarboxylic dianhydride and a 3,3′,4,4′-biphenyl tetracarboxylic dianhydride. In total, the amount of these acid components is at least 70 mol % or higher, more preferably 80 mol % or higher, even more preferably 90 mol % or higher.

For the tetracarboxylic dianhydride component used in the present invention, another tetracarboxylic dianhydride component could be used in combination with the above-described two acid components. Other tetracarboxylic dianhydride components include pyromellitic dianhydride, 3,3′,4,4′-benzophenone tetracarboxylic dianhydride, bis(3,4-dicarboxyphenyl)ether dianhydride, bis(3,4-dicarboxyphenyl) sulfide dianhydride, bis(3,4-dicarboxyphenyl) sulfone dianhydride, bis(3,4-dicarboxyphenyl) methane dianhydride, 2,2-bis(3,4-dicarboxyphenyl) propane dianhydride, 1,4-hydroquinone dibenzoate-3,3′,4,4′-tetracarboxylic dianhydride, and the like.

The diamine component used in the present invention includes as a main component an aromatic diamine compound represented by formula (I).

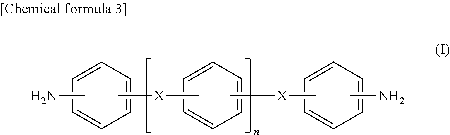

(where X is O, CO, C(CH₃)₂, CH₂, SO₂, S, or a direct bond, and in cases of two or more modes of bonding, each may be the same or different; and n is an integer of 0 to 4)

The diamine component used in the present invention includes at least 70 mol % or higher, more preferably at least 80 mol % or higher, and even more preferably at least 90 mol % or higher of a diamine component represented by formula (I) as a main component. Specific examples of the diamine component include 1,3-bis(4-aminophenoxy)benzene, 1,3-bis(3-aminophenoxy)benzene, 1,4-bis(4-aminophenoxy)benzene, 3,3′-diaminobenzophenone, 4,4′-bis(3-aminophenoxy) biphenyl, 4,4′-bis(4-aminophenoxy) biphenyl, bis[4-(3-aminophenoxy) phenyl]ketone, bis[4-(4-aminophenoxy)phenyl]ketone, bis[4-(3-aminophenoxy) phenyl]sulfide, bis[4-(4-aminophenoxy) phenyl]sulfide, bis[4-(3-aminophenoxy) phenyl]sulfone, bis[4-(4-aminophenoxy) phenyl]sulfone, bis[4-(3-aminophenoxy) phenyl]ether, bis[4-(4-aminophenoxy) phenyl]ether, 2,2-bis[4-(3-aminophenoxy)phenyl]propane, 2,2-bis[4-(4-aminophenoxy)phenyl]propane, and the like.

Particularly preferably, 1,3-bis(4-aminophenoxy)benzene can be used. One or a combination of diamine components can be used.

The polymerization of the tetracarboxylic dianhydride component and the diamine component shall be described below.

The thickness of the thermally adhesive polyimide film is greater than 0 to 75 μm, preferably 15 to 50 μm, more preferably 25 to 50 μm. According to the present invention, a relatively thick thermally adhesive polyimide film can be obtained.

### Polyimide/Metal Laminate

The polyimide/metal laminate is obtained by laminating a metallic layer onto at least one side of the thermally adhesive polyimide film. Preferably, the side of the thermally adhesive polyimide film onto which the metallic layer is laminated is a side onto which a carrier film (described below) had not been attached. The metallic layer may also be laminated onto both sides of the thermally adhesive polyimide film.

The metallic layer is preferably a metallic foil. A variety of metallic foils, such as foils of copper, aluminum, gold, or alloys can be used as the metallic foil. Particularly preferably, a copper foil is used. Specific examples of copper foils include a roller copper foil, an electrolytic copper foil, and the like.

In a case where the metallic layer is laminated onto both sides of the thermally adhesive polyimide film, it is possible to use the same metal or different metals.

The description above mentions the metallic layer as an adherend laminated to the thermally adhesive polyimide film, but there is no limitation thereto. Examples of adherends other than metals include ceramics, glasses, polyimide and the like.

The metallic foil can be used at any surface roughness, but preferably the surface roughness Rz is 0.5 μm or higher. Also, preferably, the surface roughness Rz of the metallic foil is 7 μm or lower, in particular 5 μm or lower. A metallic foil, e.g., copper foil of such description is known as very low profile (VLP), low profile (LP), or high-temperature elongation (HTE).

The thickness of the metallic foil, though not particularly limited, is preferably 2 to 35 μm, in particular 5 to 18 μm. A metallic foil provided with a carrier, e.g., a copper foil provided with an aluminum foil carrier can be used as a metallic foil of thickness 5 μm or lower.

The polyimide/metal laminate of the present invention is obtained by firmly laminating the thermally adhesive polyimide film and the metallic foil together. For example, 18 μm of copper foil is placed on both sides of the thermally adhesive polyimide film, and the assembly is pressed (thermally fused) for one minute at a temperature of 340° C. and a pressure of 3 MPa to bond the thermally adhesive polyimide film and the copper foil together. Measurements of the peel strength of the bonded polyimide/copper foil laminate (copper foil 1-thermally adhesive polyimide film-copper foil 2) are taken for the copper foil 1-thermally adhesive polyimide film and for the thermally adhesive polyimide film-copper foil 2, according to the method of JIS C6471. The peel strength is 0.5 N/mm or higher for both the copper foil 1-thermally adhesive polyimide film and the thermally adhesive polyimide film-copper foil 2. Properly selecting a carrier film (described below) makes it possible for the peel strength to be 1 N/mm or higher for both.

According to the present invention, it is possible to provide a single-layer thermally adhesive polyimide film for obtaining this polyimide/metal laminate. The thermally adhesive polyimide film of the present invention can be used as an adhesive sheet or adhesive tape.

The thermally adhesive polyimide film and polyimide/metal laminate of the present invention have favorable moldability and can be directly subjected to drilling, bending, raising, metal-wire forming, thermocompression bonding of electrical circuitry to wiring, or the like. The thermally adhesive polyimide film and the polyimide/metal laminate of the present invention can be used as materials for electronic components or electronic equipment such as printed wiring boards, flexible printed circuit boards, or TAB tapes. Moreover, the thermally adhesive polyimide film of the present invention can be suitably used as an adhesive sheet for which reliability at high temperatures is required, such as a sealant for a tab lead in a lithium ion cell, polymer cell, electrical double-layer capacitor, or the like in which an aluminum-laminated film is used as an outer covering bag, or a cover lay in a flexible printed circuit board or a bonding material between a cap and a ceramic package.

### Method for Producing the Thermally Adhesive Polyimide Film

The method for producing a thermally adhesive polyimide film in the present invention is a method for producing a single-layer thermally adhesive polyimide film, the method including a step for casting or applying a polyamic acid solution onto a carrier film and drying, and a step for heat-treating the resulting dried article to obtain a thermally adhesive polyimide film provided with a carrier film.

The polyamic acid solution is obtained by polymerizing a tetracarboxylic dianhydride component and a diamine component. The tetracarboxylic dianhydride component includes 2,3,3′,4′-biphenyl tetracarboxylic dianhydride and 3,3′,4,4′-biphenyl tetracarboxylic dianhydride. The diamine component includes an aromatic diamine compound represented by formula (I) as the main component. The carrier film is a polyimide film. The thickness of the polyimide film is 50 μm or higher.

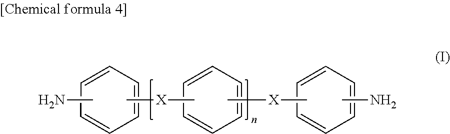

(where X is O, CO, C(CH₃)₂, CH₂, SO₂, S, or a direct bond, and in cases of two or more modes of bonding, each may be the same or different; and n is an integer of 0 to 4)

The step for casting or applying the polyamic acid solution onto the carrier film and drying shall now be described.

The polyamic acid solution can be obtained by reacting the tetracarboxylic dianhydride component and the diamine component together in an organic solvent. The tetracarboxylic dianhydride component and the diamine component are the same as what is described above. The reaction temperature is a temperature 100° C. or lower, preferably 80° C. or lower, even more preferably 0 to 60° C. The tetracarboxylic dianhydride component and the diamine component are preferably mixed in an equimolar ratio.

Organic solvents used to produce the polyamic acid include N-methyl-2-pyrrolidone, N,N-dimethylformamide, N,N-dimethylacetamide, N,N-diethyl acetamide, dimethyl sulfoxide, hexamethylphosphoramide, N-methyl caprolactam, cresols, and the like. One or more of these organic solvents may be used.

In the polyamic acid solution, the concentration of total monomer in the organic polar solvent (concentration in terms of the total amount of raw material monomer added in order to generate the polyamic acid) is preferably 5 to 40 mass %, even more preferably 6 to 35 mass %, and particularly preferably 10 to 30 mass %.

The solution viscosity of the polyamic acid (polyimide precursor) should be selected as appropriate in accordance with the purpose of use (application, casting, or the like) or purpose of production. For example, a rotational viscosity as measured at 30° C. of about 0.1 to 5000 Poise, in particular 0.5 to 2000 Poise, even more preferably about 1 to 2000 Poise is preferable in terms of the workability in handling the polyamic acid solution. As such, preferably, the polymerization reaction for generating the polyamic acid is conducted until such an extent as the resulting polyamic acid exhibits such a viscosity described above.

It would also be possible to add an above-mentioned organic solvent to the polyamic acid solution thus produced, to adjust the solution viscosity.

A phosphorus-based stabilizer, e.g., triphenyl phosphite, triphenyl phosphate, or the like can be added to the polyamic acid solution during the polyamic acid polymerization, in order to limit gelling thereof, in a range of 0.01 to 1% in relation to the concentration of total monomer in the organic polar solvent.

A basic organic compound can also be added to the polyamic acid solution for the purpose of accelerating imidization. For example, imidazole, 2-methyl imidazole, 1,2-dimethyl imidazole, 2-phenyl imidazole, benzimidazole, isoquinoline, substituted pyridine, or the like can be used at a ratio of 0.05 to 10 mass %, in particular 0.1 to 2 mass % in relation to the concentration of total monomer in the organic polar solvent.

In the present invention, it is preferable to add a phosphate ester or a salt of a tertiary amine and a phosphate ester to the polyamic acid solution, in terms of the film surface state and productivity. The amount added thereof is preferably 0.01 to 5 parts by mass in relation to 100 parts by mass of the resulting polyimide or polymer. Specific examples of phosphates include distearyl phosphate and monostearyl phosphate. Salts of a tertiary amine and a phosphate include monostearyl phosphate triethanolamine salts and the like.

The polyamic acid solution is cast or applied to a carrier film and dried. A polyimide film is preferably used as the carrier film; it is particularly preferable to use a heat-resistant polyimide. The drying temperature is, for example, 80 to 200° C., preferably 100 to 200° C. The drying treatment time is, for example, 5 to 60 minutes. A commercially available polyimide film can be used for the polyimide film serving as the carrier film.

Commercially-available polyimide films include Upilex™ made by Ube Industries, Kapton EN™ made by DuPont—Toray, Apical NPI™ made by Kaneka, and the like. Upilex (25S, 50S, 75S, 125S) is particularly preferable to use in terms of the releasability of the thermally adhesive polyimide film from the carrier film and the film rigidity.

The thickness of the polyimide film serving as the carrier film is 50 μm or higher, preferably 75 to 125 μm, in particular preferably 75 to 100 μm. This makes it possible to obtain a single-layer thermally adhesive polyimide film with which the peel strength of both sides of the thermally adhesive polyimide film is high, e.g., the peel strengths of both sides are 1 N/mm or higher, respectively.

The polyimide film serving as the carrier film is obtained by polymerizing a tetracarboxylic dianhydride component and a diamine component to obtain a polyamic acid solution, casting or applying the polyamic acid solution onto a support, and drying, yielding a self-supporting film, and thereafter heating and imidizing the self-supporting film. Herein, of the two sides of the polyimide film serving as the carrier film, a side in contact with the support when the polyamic acid solution is cast or applied onto the support is called the B-side, and a side (air-side) not in contact with the support is called the A-side.

Examples of the tetracarboxylic dianhydride component used in obtaining the polyimide film serving as the carrier film, though no particularly limited, include an acid component including at least one type of component selected from 3,3′,4,4′-biphenyl tetracarboxylic dianhydride, pyromellitic dianhydride, and 1,4-hydroquinone dibenzoate-3,3′,4,4′-tetracarboxylic dianhydride. The amount of the aforementioned acid component in the tetracarboxylic dianhydride component is, for example 70 mol % or higher, more preferably 80 mol % or higher, even more preferably 90 mol % or higher.

Examples of the diamine component in obtaining the polyimide film serving as the carrier film include a diamine component including at least one type of component selected from p-phenylenediamine, 4,4′-diaminodiphenyl ether, 3,4′-diaminodiphenyl ether, m-tolidine, and 4,4′-diaminobenzanilide. The amount of the aforementioned diamine in the diamine component is, for example, 70 mol % or higher, more preferably 80 mol % or higher, even more preferably 90 mol % or higher.

The following are included as examples of combinations of the acid component and the diamine component with which a heat-resistant polyimide can be obtained.

(1) A combination including 3,3′,4,4′-biphenyl tetracarboxylic dianhydride (s-BPDA) with p-phenylenedimaine (PPD), and 4,4-diaminodiphenyl ether (DADE) when needed. In such a case, preferably, the molar ratio PPD/DADE is 100/0 to 85/15.

(2) A combination including 3,3′,4,4′-biphenyl tetracarboxylic dianhydride (s-RPDA) and pyromellitic acid dianhydride (PMDA) with p-phenylenediamine (PPD), and 4,4-diaminodiphenyl ether (DADE) when needed. In such a case, preferably, the molar ratio s-BPDA/PMDA is 0/100 to 90/10. In a case where PPD and DADE are used in combination, the molar ratio PPD/DADE is preferably, for example, 90/10 to 10/90.

(3) A combination of pyromellitic acid dianhydride (PMDA) with p-phenylenediamine (PPD) and 4,4-diaminodiphenyl ether (DADE). In such a case, preferably, the molar ratio DADE/PPD is 90/10 to 10/90.

(4) A product obtained with 3,3′,4,4′-biphenyl tetracarboxylic dianhydride (s-BPDA) and p-phenylenediamine (PPD) as the main components (at least 50 mol % out of a total of 100 mol %).

In (1) to (3) above, it would also be possible substitute part or all of the 4,4-diaminodiphenyl ether (DADE) with 3,4′-diaminodiphenyl ether or 2,2-bis[4-(4-aminophenoxy)phenyl]propane, depending on the purpose.

In (1) to (4) above, it would also be possible to substitute part or all of the 3,3′,4,4′-biphenyl tetracarboxylic dianhydride with 3,3′,4,4′-benzophenone tetracarboxylic dianhydride, depending on the purpose.

The combination (1) above has excellent heat resistance and is therefore preferable. Using the heat-resistant polyimide obtained from the tetracarboxylic dianhydride component including 3,3′,4,4′-biphenyl tetracarboxylic dianhydride as the main component (for example, 70 mol % or higher, preferably 80 mol % or higher, even more preferably 90 mol % or higher) and the diamine component including p-phenylenediamine as the main component (for example, 70 mol % or higher, preferably 80 mol % or higher, even more preferably 90 mol % or higher) makes it possible to obtain a thermally adhesive polyimide film that has a low coefficient of linear expansion, high elastic modulus, and excellent dimensional stability.

The method for casting or applying, though not particularly limited, could be, for example, a gravure coating method, spin coating method, silk screen method, dip coating method, spray coating method, bar coating method, knife coating method, roll coating method, blade coating method, die coating method, or another such method.

The side of the carrier film to which the polyamic acid solution is cast or applied may be either the A-side or the B-side. It is particularly preferable to cast or apply the polyamic acid solution to the B-side of the carrier film. According thereto, the peel strength of the copper foil on the polyimide side of the polyimide/metal laminate is higher. Particularly in a case where the thickness of the carrier film is 75 μm or higher, preferably 75 to 125 μm, then it is preferable to cast or apply the polyamic acid solution to the B-side of the carrier film.

A step for heat-treating the dried article to obtain the thermally adhesive polyimide film provided with the carrier film shall now be described.

The dried article (provided with the carrier film) is heat-treated. This fully removes any residual solvent and also promotes imidization.

The temperature of the heat treatment is higher than the drying temperature, and is 100 to 430° C., preferably 100 to 400° C., more preferably 300 to 400° C. The heat treatment time is, for example, 1 to 100 minutes. The maximum heating temperature of the heat treatment is preferably 430° C. or lower; 270 to 430° C. is more preferable, and 340 to 350° C. is even more preferable. This makes it possible to obtain a single-layer thermally adhesive polyimide film of which the peel strengths of both sides are 1 N/mm or higher, respectively.

The heat treatment is carried out continuously or intermittently. The heat treatment, in a case of continuous performance, is performed in a state where at least a pair of two edges of the film, which is the dried article, are fixed with a movable fixing device or the like. The heat treatment can be carried out using a device such as a hot air furnace or an infrared heating furnace. As a suitable example, a fixing device can have a pair of implements in the form of a belt or chain provided with a plurality of equally spaced pins, holders, or the like installed along both longitudinal side edges of a continuously or intermittently supplied film (dried article), it being possible to fix the film while continuously or intermittently moving the pair of implements as the film moves. The fixing device may also be a device with which a film being heat-treated can be elongated/shrunk in the width direction or longitudinal direction at an appropriate rate of elongation or rate of shrinkage (particularly preferably, a factor of elongation/shrinkage of about 0.5 to 5%).

The thermally adhesive polyimide film can be made into a thermally adhesive polyimide film having particularly excellent dimensional stability when heat-treated at a temperature of 100 to 400° C. for preferably 0.1 to 30 minutes at, again preferably, a low tension of 400 gf/mm² or lower, particularly preferably 300 gf/mm² or lower, or under no tension. The elongated thermally adhesive polyimide film provided with a carrier film thus produced can be wound into a roll.

The carrier film is released from the thermally adhesive polyimide film provided with the carrier film. This makes it possible to obtain a single-layer thermally adhesive polyimide film. The thermally adhesive polyimide film of the present invention has favorable releasability from the carrier film. For example, in a case where Upilex, mentioned above as a carrier film, the thermally adhesive polyimide film can be released from the carrier film at an extremely low peel strength of 0.05 N/mm or lower, preferably 0.02 N/mm or lower, even more preferably 0.01 N/mm or lower.

### Method for Producing the Polyimide/Metal Laminate

A metallic layer is placed onto both sides of the single-layer thermally adhesive polyimide film from which the carrier film has been released, resulting from the above description, and the thermally adhesive polyimide film and the metallic layers are thermally compression-bonded together. This makes it possible to obtain a polyimide/metal laminate with which a metallic layer is laminated onto both sides of the thermally adhesive polyimide film.

The metallic layer is also placed on one side of the single-layer thermally adhesive polyimide film from which the carrier film has been released, and the thermally adhesive polyimide film and the metallic layer are thermally compression-bonded. This makes it possible to obtain a polyimide/metal laminate with which a metallic layer is laminated onto one side of the thermally adhesive polyimide film.

When obtaining the polyimide/metal laminate in which the metallic layer is laminated onto one side, it may involves placing the metallic layer onto the side (air side), of the sides of the thermally adhesive polyimide film, to which the carrier film was not attached, and thermally compression-bonding the thermally adhesive polyimide film and the metallic layer. This causes the peel strength between the polyimide film and the metallic layer to be greater than a case where the metallic layer is laminated onto the side (polyimide side) to which the carrier film was attached.

The metallic layer is of the same content as is described above.

The method for thermally compression-bonding the thermally adhesive polyimide film and the metallic layer(s) shall now be described. Preferably, the thermally adhesive polyimide film and a metallic foil are continuously thermally compression-bonded while being heated with at least a pair of compression members, the temperature of the compression parts being 30 to 420° C. higher than the glass transition temperature of the thermally adhesive polyimide.

Compression members include a pair of compression-bonding metal rolls (the compression-bonding part may be made of metal or made of a ceramic sprayed metal), a double belt press, or a hot press, and in particular those enabling thermal compression-bonding and cooling under pressurization, among which a hydraulic double belt press would be particularly suitable.

In the present invention, the compression members, e.g., metal rolls, suitably a double belt press, can be used to overlay the thermally adhesive polyimide film, the metallic foil, and a reinforcing material, then thermally compression-bond continuously with heating to produce a polyimide/metal laminate in an elongated form.

This is particularly suitable for a case where the thermally adhesive polyimide film and the metallic foil are used in a rolled-up state, are each continuously supplied to the compression members to obtain a single-sided metallic foil-laminated leaf in a rolled-up state.

### EXAMPLES

The present invention shall be described below in even greater detail on the basis of examples. The present invention is not, however, limited by the examples.

The various measurement conditions were as follows.

### Peel Strength of the Thermally Adhesive Polyimide Film from the Carrier Film

Measured at a 30-mm width, MD direction, crosshead speed 50 mm/min, by the 90° peel test set forth in JIS C6471.

### Peel Strength of Polyimide/Copper Foil Laminate

Measured at a 10-mm width, MD direction, crosshead speed 50 mm/min, by the 180° peel test set forth in JIS C6471.

For the carrier film, the following polyimide films were used.

Upilex 25S (Ube Industries; 25 μm thick)

Upilex 50S (Ube Industries; 50 μm thick)

Upilex 75S (Ube Industries; 75 μm thick)

Upilex 125S (Ube Industries; 125 μm thick)

The polyimide films were obtained by using 3,3′,4,4′-biphenyl tetracarboxylic dianhydride as the tetracarboxylic dianhydride component and p-phenylenediamine as the diamine component, polymerizing both to obtain the polyamic acid solution, casting or applying the polyamic acid solution onto a support, and drying, thereby obtaining a self-supporting film, and then heating and imidizing the self-supporting film. Of the two sides of the polyimide film serving as the carrier film, the side in contact with the support when the polyamic acid solution is cast or applied onto the support is called the B-side, and the side (air-side) not in contact with the support is called the A-side.

### Preparation of the Polyamic Acid Solution

1,3-bis(4-aminophenoxy)benzene (TPE-R), 2,3,3′,4′-biphenyl tetracarboxylic dianhydride (a-BPDA), and 3,3′,4,4′-biphenyl tetracarboxylic dianhydride (s-BPDA) were added in N,N-dimethylacetamide at a molar ratio of 1000:200:800; 0.5 mass % monostearyl phosphate triethanolamine salt, with respect to the monomer weight, was added so that the monomer concentration reached 18 mass %, and the reaction was allowed to proceed for three hours at 40° C. The solution viscosity of the resulting polyamic acid solution at 25° C. was 1680 Poise.

### Preparation of Thermally Adhesive Polyimide Film and Assessment of Peel Strength from Carrier Film

### Example 1

### Carrier Film 75S (A-Side)

### Thermally Adhesive Polyimide Film, 15 μm

The resulting polyamic acid solution was applied with a bar coater onto the A-side of the Upilex 75S as the carrier film, with eight minutes of heating and drying at 120° C. Thereafter, a thermally adhesive polyimide film provided with a carrier film was prepared by heating with a holding time of two minutes at each temperature in 30° C. increments, from 130° C. to 340° C. (340° C. being the maximum heating temperature) in a hot air furnace while the carrier film remained attached, to remove the solvent and imidize.

The peel strength of the thermally adhesive polyimide film relative to the carrier film was measured by the method described above. The results are shown in Table 1. The peel strength was very low. The outer appearance of the thermally adhesive polyimide film was also favorable.

The carrier film was released to obtain a single-layer thermally adhesive polyimide film 15-μm thick.

### Example 2

### 75S (A-Side)-25 μm

The resulting polyamic acid solution was applied with a bar coater onto the A-side of the Upilex 75S as the carrier film, with 12 minutes of heating and drying at 120° C. Thereafter, a thermally adhesive polyimide film provided with a carrier film was prepared by heating with a holding time of two minutes at each temperature in 30° C. increments, from 130° C. to 340° C. (340° C. being the maximum heating temperature) in a hot air furnace while the carrier film remained attached, to remove the solvent and imidize.

The peel strength of the thermally adhesive polyimide film relative to the carrier film was measured by the method described above. The results are shown in Table 1. The peel strength was very low. The outer appearance of the thermally adhesive polyimide film was also favorable.

The carrier film was released to obtain a single-layer thermally adhesive polyimide film 25-μm thick.

### Example 3

### 75S (A-Side)-50 μm

The resulting polyamic acid solution was applied with a bar coater onto the A-side of the Upilex 75S as the carrier film, with 25 minutes of heating and drying at 110° C. Thereafter, a thermally adhesive polyimide film provided with a carrier film was prepared by heating with a holding time of two minutes at each temperature in 30° C. increments, from 130° C. to 340° C. (340° C. being the maximum heating temperature) in a hot air furnace while the carrier film remained attached, to remove the solvent and imidize.

The peel strength of the thermally adhesive polyimide film relative to the carrier film was measured by the method described above. The results are shown in Table 1. The peel strength was very low. The outer appearance of the thermally adhesive polyimide film was also favorable.

The carrier film was released to obtain a single-layer thermally adhesive polyimide film 50-μm thick.

### Synthesis Examples 1 to 7

Thermally adhesive polyimide films provided with a carrier film were prepared by a method similar to that of examples 1 to 3 except that the carrier film was changed to Upilex 25S (25 μm thick), 50S (50 μm thick), or 1255 (125 μm thick) and the thickness of the thermally adhesive polyimide film was set as is shown in table 1.

The peel strength of the thermally adhesive polyimide film relative to the carrier film was measured by the method described above. The results are shown in Table 1. The peel strength was very low. The outer appearance of the thermally adhesive polyimide film was also favorable.

The carrier film was released to obtain single-layer thermally adhesive polyimide films 15-, 25-, and 50-μm thick.

TABLE 1

| | | Thermally adhesive | |
|---|---|---|---|
| | Carrier film | polyimide film | |
| | Thickness | Thickness | Peel strength |
| | μm | μm | N/mm |
| Example 1 | 75 | 15 | 0.007 |
| Example 2 | 75 | 25 | 0.006 |
| Example 3 | 75 | 50 | 0.006 |
| Synthesis | 25 | 15 | 0.004 |
| example 1 | | | |
| Synthesis | 25 | 25 | 0.003 |
| example 2 | | | |
| Synthesis | 25 | 50 | 0.002 |
| example 3 | | | |
| Synthesis | 50 | 15 | 0.003 |
| example 4 | | | |
| Synthesis | 50 | 25 | 0.002 |
| example 5 | | | |
| Synthesis | 50 | 50 | 0.002 |
| example 6 | | | |
| Synthesis | 125 | 25 | 0.008 |
| example 7 | | | |

### Example 4

### 75S (B-Side)-25 μm

A thermally adhesive polyimide film provided with a carrier film was prepared by a method similar to that of example 2, except for a change to the B-side of the Upilex 75S as the carrier film.

The peel strength of the thermally adhesive polyimide film relative to the carrier film was measured by the method described above. The peel strength was similar to that of example 2, and was very low. The outer appearance of the thermally adhesive polyimide film was also favorable.

The carrier film was released to obtain a single-layer thermally adhesive polyimide film 25-μm thick.

### Synthesis Example 8

### 50S (B-Side)-25 μm

A thermally adhesive polyimide film provided with a carrier film was prepared by a method similar to that of synthesis example 5, except for a change to the B-side of the Upilex 50S as the carrier film.

The peel strength of the thermally adhesive polyimide film relative to the carrier film was measured by the method described above. The peel strength was similar to that of synthesis example 5, and was very low. The outer appearance of the thermally adhesive polyimide film was also favorable.

The carrier film was released to obtain a single-layer thermally adhesive polyimide film 25-μm thick.

### Synthesis Example 9

### 125S (B-Side)-25 μm

A thermally adhesive polyimide film provided with a carrier film was prepared by a method similar to that of synthesis example 7, except for a change to the B-side of the Upilex 1255 as the carrier film.

The peel strength of the thermally adhesive polyimide film relative to the carrier film was measured by the method described above. The peel strength was similar to that of synthesis example 7, and was very low. The outer appearance of the thermally adhesive polyimide film was also favorable.

The carrier film was released to obtain a single-layer thermally adhesive polyimide film 25-μm thick.

### Preparation of Polyimide/Copper Foil Laminate and Assessment of Peel Strength Between Thermally Adhesive Polyimide Film and Copper Foil

### Example 5

### 75S (A-Side)-15 μm

A copper foil (rolled copper foil; Nippon Mining & Metals BHY-13H-T, 18 μm thick) was superimposed onto both sides of the single-layer thermally adhesive polyimide film obtained in example 1. A polyimide/metal laminate was prepared by ten minutes of pre-heating of the superimposed thermally adhesive polyimide film and copper foil at 340° C., followed by a one-minute compression-bonding time of thermal compression-bonding at a heating temperature of 340° C. and compression-bonding pressure of 3 MPa. The peel strength of the polyimide/metal laminate was measured by the method described above. The results are shown in table 2. In table 2, the “air side” refers to the side of the thermally adhesive polyimide film to which the carrier film was not attached, and is indicative of the peel strength between that side of the thermally adhesive polyimide film and the copper foil. The “polyimide side” refers to the side of the thermally adhesive polyimide film to which the carrier film was attached, and is indicative of the peel strength between that side of the thermally adhesive polyimide film and the copper foil. The peel strength was 1 N/mm or higher for both sides of the polyimide/metal laminate. The outer appearance of the polyimide/metal laminate was also favorable.

### Example 6

### 75S (A-Side)-25 μm

A polyimide/metal laminate was prepared by a method similar to that of example 5, except in that the single-layer thermally adhesive polyimide film obtained in example 2 was used. Table 2 shows the results of measuring the peel strength. The peel strength was 1 N/mm or higher for both sides of the polyimide/metal laminate. The outer appearance of the polyimide/metal laminate was also favorable.

### Example 7

### 75S (B-Side)-25 μm

A polyimide/metal laminate was prepared by a method similar to that of example 5, except in that the single-layer thermally adhesive polyimide film obtained in example 4 was used. Table 2 shows the results of measuring the peel strength. The peel strength was 1 N/mm or higher for both sides of the polyimide/metal laminate. The outer appearance of the polyimide/metal laminate was also favorable.

### Synthesis Example 10

### 25S (A-Side)-25 μm

A polyimide/metal laminate was prepared by a method similar to that of example 5, except in that the single-layer thermally adhesive polyimide film obtained in synthesis example 2 was used. Table 2 shows the results of measuring the peel strength.

### Synthesis Example 11

### 50S (A-Side)-25 μm

A polyimide/metal laminate was prepared by a method similar to that of example 5, except in that the single-layer thermally adhesive polyimide film obtained in synthesis example 5 was used. Table 2 shows the results of measuring the peel strength.

### Synthesis Example 12

### 50S (B-Side)-25 μm

A polyimide/metal laminate was prepared by a method similar to that of example 5, except in that the single-layer thermally adhesive polyimide film obtained in synthesis example 8 was used. Table 2 shows the results of measuring the peel strength.

### Synthesis Example 13

### 125S (A-Side)-25 μm

A polyimide/metal laminate was prepared by a method similar to that of example 5, except in that the single-layer thermally adhesive polyimide film obtained in synthesis example 7 was used. Table 2 shows the results of measuring the peel strength.

### Synthesis Example 14

### 125S (B-Side)-25 μm

A polyimide/metal laminate was prepared by a method similar to that of example 5, except in that the single-layer thermally adhesive polyimide film obtained in synthesis example 9 was used. Table 2 shows the results of measuring the peel strength.

TABLE 2

| | | | Thermally | | |
|---|---|---|---|---|---|
| | | | adhesive | Copper foil peel | |
| | | | polyimide | strength | |
| | Carrier film | | film | | Polyimide |
| | Thickness | | Thickness | Air side | side |
| | μm | Side | μm | N/mm | N/mm |
| Example 5 | 75 | A | 15 | 1.66 | 1.06 |
| Example 6 | 75 | A | 25 | 1.36 | 1.04 |
| Example 7 | 75 | B | 25 | 1.39 | 1.26 |
| Synthesis | 25 | A | 25 | 1.26 | 0.61 |
| example 10 | | | | | |
| Synthesis | 50 | A | 25 | 1.35 | 0.78 |
| example 11 | | | | | |
| Synthesis | 50 | B | 25 | 1.30 | 0.82 |
| example 12 | | | | | |
| Synthesis | 125 | A | 25 | 1.23 | 0.74 |
| example 13 | | | | | |
| Synthesis | 125 | B | 25 | 1.24 | 0.94 |
| example 14 | | | | | |

### Example 8

A thermally adhesive polyimide film provided with a carrier film was prepared by a method similar to that of example 2, except in that the maximum heating temperature was modified to 270° C. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

### Example 9

A thermally adhesive polyimide film provided with a carrier film was prepared by a method similar to that of example 2, except in that the maximum heating temperature was modified to 300° C. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

### Example 10

A thermally adhesive polyimide film provided with a carrier film was prepared by a method similar to that of example 2, except in that the maximum heating temperature was modified to 350° C. The carrier film was released to obtain a single-layer thermally adhesive polyimide film 25-μm thick. With a tensile strength of 133 MPa, a rate of elongation of 136%, and an elastic modulus of 2.90 GPa, the thermally adhesive polyimide film was demonstrated to possess mechanical properties suitable for practical use. The tensile strength, rate of elongation, and elastic modulus were measured by the method in ASTM D882, the method in ASTM D882, and the method in ASTM D882, respectively.

Next, this single-layer thermally adhesive polyimide film was used to prepare a polyimide/metal laminate by a method similar to that of example 5. The peel strength of the polyimide/metal laminate was measured by the method described above. The results are shown in Table 3.

### Example 11

A thermally adhesive polyimide film provided with a carrier film was prepared by a method similar to that of example 10, except in that the maximum heating temperature was modified to 350° C. and the holding time was modified from two minutes to five minutes. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

### Example 12

A thermally adhesive polyimide film provided with a carrier film was prepared by a method similar to that of example 10, except in that the maximum heating temperature was modified to 350° C. and the holding time was modified from two minutes to ten minutes. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

### Example 13

A thermally adhesive polyimide film provided with a carrier film was prepared by a method similar to that of example 2, except in that the maximum heating temperature was modified to 430° C. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

### Synthesis Example 15

A thermally adhesive polyimide film provided with a carrier film was prepared by a method similar to that of example 2, except in that the maximum heating temperature was modified to 450° C. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

### Synthesis Example 16

A thermally adhesive polyimide film provided with a carrier film was prepared by a method similar to that of example 2, except in that the maximum heating temperature was modified to 470° C. The carrier film was released to obtain a single-layer thermally adhesive polyimide film 25-μm thick. This single-layer thermally adhesive polyimide film was used to prepare a polyimide/metal laminate by a method similar to that of example 5. The peel strength of the polyimide/metal laminate was measured by the method described above. The results are shown in Table 3.

TABLE 3

| | Maximum heating | Copper foil peel strength | |
|---|---|---|---|
| | temperature | Air side | Polyimide side |
| | ° C | N/mm | N/mm |
| Example 8 | 270 | 1.02 | 1.05 |
| Example 9 | 300 | 1.00 | 1.01 |
| Example 10 | 350 | 1.40 | 1.18 |
| Example 11 | 350 | 1.45 | 1.24 |
| Example 12 | 350 | 1.46 | 1.31 |
| Example 13 | 430 | 1.31 | 1.14 |
| Synthesis example 15 | 450 | 1.27 | 0.55 |
| Synthesis example 16 | 470 | 1.21 | 0.34 |

The above results demonstrate the following.

(1) The copper foil peel strength of the air side of the polyimide/metal laminate is higher than that of the polyimide side.

(2) In a case where the thickness of the carrier film is 50 μm or more, then the copper foil peel strength of the polyimide/metal laminate is high for both the air side and polyimide side, at 0.7 N/mm or higher.

(3) The copper foil peel strength of the air side of the polyimide/metal laminate in a case where the B-side of the carrier film is used is substantially equivalent to in a case where the A-side of the carrier film is used. By contrast, the copper foil peel strength of the polyimide side of the polyimide/metal laminate in a case where the B-side of the carrier film is used is higher than in a case where the A-side of the carrier film is used.

1. A single-layer thermally adhesive polyimide film obtained by polymerizing a tetracarboxylic dianhydride component and a diamine component,
the tetracarboxylic dianhydride component comprises a 2,3,3′,4′-biphenyl tetracarboxylic dianhydride and a 3,3′,4,4′-biphenyl tetracarboxylic dianhydride;
the diamine component comprises an aromatic diamine compound represented by a formula (I), as a main component; 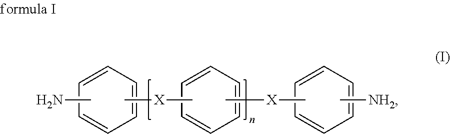
wherein X is O, CO, C(CH₃)₂, CH₂, SO₂, S, or a direct bond, and in cases of two or more modes of bonding, each is the same or different; and n is an integer of 0 to 4,
and in a polyimide/copper foil laminate obtained by placing an 18-μm copper foil onto both sides of the thermally adhesive polyimide film and pressing the resulting assembly for one minute at a temperature of 340° C. and a pressure of 3 MPa to bond the thermally adhesive polyimide film and the copper foil together, the peel strength as measured by the method in JIS C6471 is 1 N/mm or higher for both sides.

2. The thermally adhesive polyimide film according to claim 1, wherein the thermally adhesive polyimide film has a thickness of 15 to 50 μm.

3. The thermally adhesive polyimide film according to claim 1, the aromatic diamine compound is 1,3-bis(4-aminophenoxy)benzene.

4. A polyimide/metal laminate obtained by laminating a metallic layer onto both sides of the thermally adhesive polyimide film according to claim 1.

5. A method for producing a single-layer thermally adhesive polyimide film, the method comprising:
(a) casting or applying a polyamic acid solution onto a carrier film and drying the resulting film to form a dried article, and
(b) heat-treating the resulting dried article from step (a) to obtain a thermally adhesive polyimide film provided with the carrier film,
wherein the polyamic acid solution is obtained by polymerizing a tetracarboxylic dianhydride component and a diamine component, the tetracarboxylic dianhydride component comprising 2,3,3′,4′-biphenyl tetracarboxylic dianhydride and 3,3′,4,4′-biphenyl tetracarboxylic dianhydride, and the diamine component comprising an aromatic diamine compound represented by formula (I) as a main component, 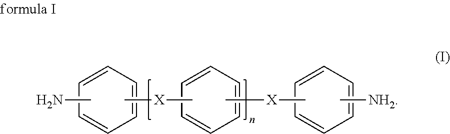
wherein X is O, CO, C(CH₃)₂, CH₂, SO₂, S, or a direct bond, and in cases of two or more modes of bonding, each may be is the same or different; and n is an integer of 0 to 4,
and the carrier film is a polyimide film, the thickness of the polyimide film being 50 μm or higher.

6. The method for producing a thermally adhesive polyimide film according to claim 5, wherein the heat treating of the dried article is carried out at a maximum temperature of 430° C. or lower.

7. The method for producing a thermally adhesive polyimide film according to claim 5, further comprising releasing the carrier film from the thermally adhesive polyimide film provided with the carrier film.

8. The method for producing a thermally adhesive polyimide film according to claim 5, the polyimide film serving as the carrier film being obtained by polymerizing the tetracarboxylic dianhydride component and the diamine component to obtain a polyamic acid solution, casting or applying the polyamic acid solution onto a support, and drying the resulting support to obtain a self-supporting film, and thereafter heating and imidizing the self-supporting film; the polyamic acid solution being cast or applied onto a side of the carrier film with which the support had not been in contact.

9. A method for producing a polyimide/metal laminate onto both sides of which a metallic layer has been laminated, the method comprising placing a metallic layer onto both sides of the single-layer thermally adhesive polyimide film obtained in claim 7, from which the carrier film has been released, and thermally compression-bonding the thermally adhesive polyimide film and the metallic layers together.

10. A method for producing a polyimide/metal laminate onto one side of which a metallic layer has been laminated, the method comprising placing a metallic layer onto the side to which the carrier film had not been attached, out of both sides of the single-layer thermally adhesive polyimide film obtained in claim 7, from which the carrier film has been released, and thermally compression-bonding the thermally adhesive polyimide film and the metallic layer together.
